(19) United States
(12) Patent Application Publication
(10) Pub. No.: US 2013/0292237 A1
(43) Pub. Date: Nov. 7, 2013

(54) SWITCH AND INPUT DEVICE

(71) Applicants: Kan Arai, Tokyo (JP); Kazuhito Murata, Tokyo (JP)

(72) Inventors: Kan Arai, Tokyo (JP); Kazuhito Murata, Tokyo (JP)

(73) Assignee: NEC Corporation, Tokyo (JP)

(21) Appl. No.: 13/980,303

(22) PCT Filed: Dec. 28, 2011
(86) PCT No.: PCT/JP2011/080596

§ 371 Date: Jul. 17, 2013

(30) Foreign Application Priority Data
Jan. 21, 2011 (JP) 2011-010873

(51) Int. Cl. H01H 13/85; H01H 13/14

(52) U.S. Cl. CPC H01H 13/85; H01H 13/14
USPC 200/5 A; 200/521

(57) ABSTRACT

Provided are a switch and input device that can give a user a switch pressing sensation and push-back sensation and that are highly quiet. This switch 1 comprises a pressure transmitting member 2, which is formed from a medium that transfers changes in pressure and which transfers pressure change in a prescribed direction when pressed, and a push-back member 3 that is disposed adjacent to the pressure transmitting member 2 and pushes the pressure transmitting member 2 back in the direction opposite to the prescribed direction when transmission of a pressure change in the prescribed direction is detected.

### TECHNICAL FIELD

The invention relates to a switch and an input device.

### BACKGROUND ART

In an input device which is included in an electronic device, like a PC (Personal computer) and a mobile phone, a momentary switch which returns to an original position after pressed is needed. The momentary switch is used for various uses, for example, an on-off operation in a power source, input of figures or letters by using a keyboard and extraction of media, like a CD (Compact Disc).

The momentary switch which is commonly used is, for example, a membrane switch with a pantograph mechanism which is used for a PC keyboard, a coil spring switch for an on-off switch in a power source, a metal dome switch disposed on a mobile phone, or the like. These switches are repeatedly pressed.

When a switch is pressed, a contacting sound due to contact between the switch and a connection base occurs. Further, when the pressed switch returns to an original position by a spring, a backlash sound due to mechanical looseness occurs. The contacting sound and the backlash sound make a user feel uncomfortable. Therefore, a switch which is highly quiet and dose not make an unnecessary sound when the switch is operated is required.

A technology related to improvement of switch quietness is described in patent document 1. Patent document 1 discloses a switch formed by a touch-panel. In the switch, a compressible medium is encapsulated just below a plate-like member. In the switch of the patent document 1, the contact sound which is generated at the time of switch operation is small, compared with the membrane switch with the common pantograph mechanism in which a medium is not encapsulated. It is, however, difficult for a user to have an operational sensation at the time of switch operation when the switch described in patent document 1 is used.

A technology related to the operational sensation at the time of switch operation is described in patent document 2. Patent document 2 discloses a panel module which gives a user the operational sensation by vibrating the panel when the panel is pressed.

### PRIOR ART DOCUMENT

### Patent Document

Patent document 1: Japanese Patent Application Laid-Open No. 2008-059037

Patent document 2: Japanese Patent Application Laid-Open No. 2009-053857

### BRIEF SUMMARY OF THE INVENTION

### Problems to be Solved by the Invention

However, the panel module described in 1 patent document 2 is not able to give a user a switch pressing sensation and a push-back sensation after pressing.

An object of the invention is to provide a switch and an input device which are highly quiet and can give a user the switch pressing sensation and the push-back sensation.

### Means for Solving the Problems

A switch of the invention to achieve the above object includes a pressure transmitting member, which is formed from a medium that transfers changes in pressure and which transfers pressure change in a prescribed direction when pressed and, a push-back member that is disposed adjacent to the pressure transmitting member and pushes the pressure transmitting member back in the direction opposite to the prescribed direction when transmission of a pressure change in the prescribed direction is detected.

An input device of the invention to achieve the above object includes a plurality of the switches described above and inputs information corresponding to the pressed switch to a prescribed electric device when the pressure transmitting member in the switch is pressed.

### Effect of the Invention

The switch and the input device of the invention are highly quiet and can give a user the switch pressing sensation and the push-back sensation.

### BRIEF DESCRIPTION OF THE DRAWINGS

FIG. 1 is an example of a cross-sectional view of a switch 1 related to a first exemplary embodiment of the invention,

FIG. 2 is an example of a cross-sectional view of a switch 10 related to a second exemplary embodiment of the invention,

FIG. 3A is an example of a cross-sectional view of the switch 10, in which a press section 11 is pressed, related to the second exemplary embodiment of the invention,

FIG. 3B is an example of a cross-sectional view of the switch 10, in which the press section 11 is pushed back, related to the second exemplary embodiment of the invention,

FIG. 4 is an example of a cross-sectional view of another switch 10B related to the second exemplary embodiment of the invention,

FIG. 5 is an example of a cross-sectional view of a switch 20 related to a third exemplary embodiment of the invention,

FIG. 6A is an example of a cross-sectional view of the switch 20, in which a press section 21 is pressed, related to the third exemplary embodiment of the invention,

FIG. 6B is an example of a cross-sectional view of the switch 20, in which the press section 21 is pushed back, related to the third exemplary embodiment of the invention,

FIG. 7 is an example of an operation flow chart of the switch 20 related to the third exemplary embodiment of the invention,

FIG. 8 is an example of a cross-sectional view of a switch 30 related to a fourth exemplary embodiment of the invention,

FIG. 9A is an example of a cross-sectional view of the switch 30, in which a press section 31 is pressed, related to the fourth exemplary embodiment of the invention,

FIG. 9B is an example of a cross-sectional view of the switch 30, in which the press section 31 which is pushed back related to the fourth exemplary embodiment of the invention,

FIG. 10 is an example of a cross-sectional view of a switch 40 related to a fifth exemplary embodiment of the invention,

FIG. 11 is an example of a cross-sectional view of the switch 40, in which a press section 41 is pressed, related to the fifth exemplary embodiment of the invention,

FIG. 12 is an example of a top view of an input device 50 related to a sixth exemplary embodiment of the invention,

FIG. 13 is an example of a cross-sectional view of the input device 50 related to the sixth exemplary embodiment of the invention, and

FIG. 14 is an example of a cross-sectional view of another input device 60 related to the sixth exemplary embodiment of the invention.

### MODE FOR CARRYING OUT THE INVENTION

### First Exemplary Embodiment

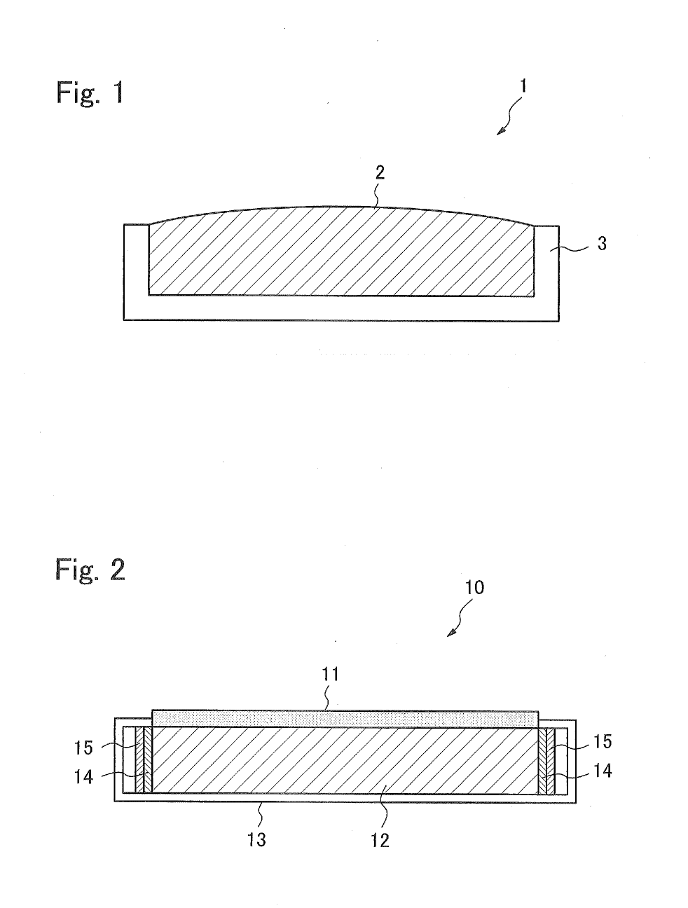

A first exemplary embodiment of the invention is described. A cross-sectional view of a switch related to the exemplary embodiment is illustrated in FIG. 1. In FIG. 1, the switch 1 related to the exemplary embodiment includes a pressure transmitting member 2 and a push-back member 3.

The pressure transmitting member 2 includes a medium which transfers a pressure change and, transfers the pressure change in a prescribed direction when pressed. The pressure transmitting member 2 can be formed, for example, by encapsulating a liquid in a closed space which is made by a liquid-resistant sheet or the like. When a user presses the pressure transmitting member 2, a pressure is applied to the pressure transmitting member 2, density of the pressure transmitting member 2 changes and the pressure transmitting member 2 is displaced. When the pressure transmitting member 2 is displaced, a further pressure change occurs and, the pressure transmitting member 2 is consecutively displaced. The pressure change is transferred in a prescribed direction due to consecutive displacement of the pressure transmitting member 2.

The push-back member 3 is disposed adjacent to the pressure transmitting member 2 and pushes the pressure transmitting member 2 back in the direction opposite to the prescribed direction when transmission of the pressure change in the prescribed direction is detected. When the pressure transmitting member 2 is displaced in the prescribed direction, the push-back member 3 determines that the pressure change is transferred in the prescribed direction and pushes the pressure transmitting member 2 back in the direction opposite to the prescribed direction. In this case, a pressure is applied to the pressure transmitting member 2 in the direction opposite to the prescribed direction and, the pressure change is transferred in the direction opposite to the prescribed direction.

In the switch 1 configured as above descriptions, when a user presses the pressure transmitting member 2, the pressure transmitting member 2 is consecutively displaced in the prescribed direction. It is, therefore, possible to give a sensation of pressing the switch 1 to a user who touches the pressure transmitting member 2.

When the pressure transmitting member 2 is displaced in the prescribed direction, the push-back member 3 pushes the pressure transmitting member 2 back in the direction opposite to the prescribed direction. Thereby, a pressure is applied to the pressure transmitting member 2 in the direction opposite to the prescribed direction and a pressure change is transferred in the direction opposite to the prescribed direction. It is, therefore, possible to give a push-back sensation from the switch 1 to a user who touches the pressure transmitting member 2.

Since the pressure transmitting member 2 is formed from the medium that transfers pressure changes, occurrence of unnecessary sounds can be reduced even though the pressure transmitting member 2 is displaced in the prescribed direction to touch the push-back member 3.

The switch 1 of the exemplary embodiment is highly quiet and can give a pressing sensation of the switch 1 and a push-back sensation thereof to a user.

The push-back member 3 can be formed from a piezoelectric element, which bends in the prescribed direction to output an output voltage when the pressure transmitting member 2 is displaced in the prescribed direction and, bends in the direction opposite to the prescribed direction to push the pressure transmission member 2 back in the direction opposite to the prescribed direction when an applied voltage is applied thereto. In this case, the switch 1 may include an applying member for applying the applied voltage to the push-back member when the output voltage is outputted from the push-back member 3.

A solid member which is pressed with a user's finger may be disposed on an upper side of the pressure transmitting member 2. In this case, when the solid member is pressed with the user's finger to move downward, the pressure transmitting member 2 is pressed to transfer the pressure change in the prescribed direction.

### Second Exemplary Embodiment

A second exemplary embodiment is described. FIG. 2 is a cross-sectional view of a switch related to the exemplary embodiment. In FIG. 2, a switch 10 related to the exemplary embodiment includes a press section 11, a medium 12, an exterior body 13, a sensor 14 and a driving section 15.

Conducting a prescribed input, a user of the switch 10 presses the press section 11 with the user's finger. In the exemplary embodiment, the press section 11 is formed of a resilient member. The medium 12 is disposed below the press section 11 and is made of a liquid. The medium 12 is deformed in response to displacement of the press section 11.

The exterior body 13 covers the medium 12, the sensor 14 and the driving section 15. The sensor 14 senses that the press section 11 is pressed. A piezoelectric element may be employed as the sensor 14. When the sensor 14 senses that the press section 11 is pressed, the driving section 15 generates stress, which is directed to the press section 11, in the direction opposite to the direction of the press.

The press section 11 corresponds to the solid member described in the claims, the medium 12 corresponds to the pressure transmitting medium described in the claims and, the sensor 14 and the driving section 15 correspond to the push-back member described in the claims.

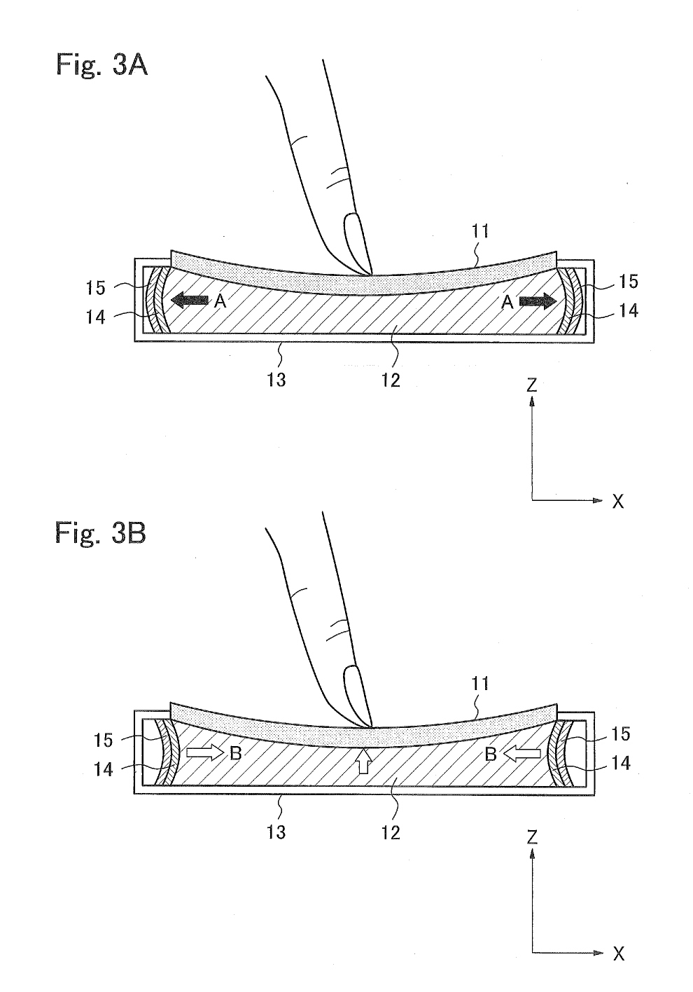

A pressing operation of the switch 10 related to the exemplary embodiment is described. In FIG. 3A, when a user presses the press section 11 in the negative direction of the z-axis with the user's finger, the press section 11 moves in the negative direction of the z-axis and the medium 12 disposed below the press section 11 is deformed. As illustrated in FIG. 3A, when the medium 12 is deformed, stress A is applied to the sensor 14 including the piezoelectric element. The sensor 14 senses that the press section 11 is pressed by detecting the stress A.

Since the press section 11 is formed from a resilient member, the press section 11 is deformed when a user presses the press section 11. Pressing the press section 11, the user, therefore, can have a sensation of pressing the switch 10. Since the medium 12 is disposed below the press section 11, it is possible to suppress contact between the press section 11 and the exterior body 13 when the press section 11 moves in the negative direction of the z-axis. Accordingly, occurrence of an unnecessary sound at the time of the press is reduced.

Next, a push-back operation of the switch related to the exemplary embodiment is described. When the sensor 14 senses that the press section 11 is pressed, the driving section 15 drives. In the exemplary embodiment, the driving section 15 includes the piezoelectric element. When the sensor 14 senses that the press section 11 is pressed, the driving section 15 applies a voltage to the piezoelectric element and generates stress B in the direction opposite to the direction of the stress A. In FIG. 3B, when stress B in the direction opposite to the direction of the stress A is applied to the medium 12, stress in the positive direction of the z-axis is applied to the press section 11. When the stress in the positive direction of the z-axis is applied to the press section 11, a user who touches the press section 11 with the user's finger can have a push-back sensation from the switch 10.

As described above, the switch 10 related to the exemplary embodiment is highly quiet and can give a user the pressing sensation of the switch 10 and the push-back sensation thereof.

The sensor 14 is not limited to the piezoelectric element. A pressure resistance change sensor, an electrostatic capacity sensor, or the like may be employed as the sensor 14. The driving section 15 may be a section which is driven by magnetic, electric current, or the like.

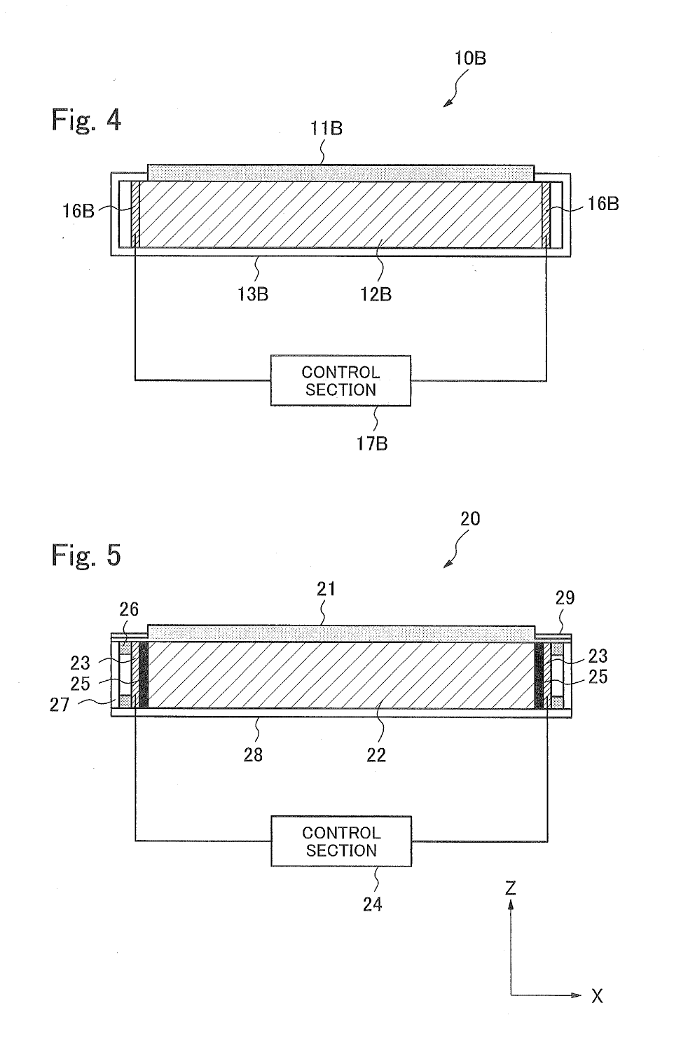

In the exemplary embodiment, each of the sensor 14 and driving section 15 is a separate member. One piezoelectric element having both functions may be employed therein. FIG. 4 is a cross-sectional view of a switch which employs the piezoelectric element having the both functions of the sensor 14 and the driving section 15. In FIG. 4, a switch 10B includes a piezoelectric element 16B having the both functions of the sensor 14 and the driving section 15 and, a control section 17B for controlling the piezoelectric element 16B. A press section 11B, a medium 12B, and an exterior body 13B have functions as same as those of the press section 11, the medium 12, and the exterior body 13 shown in FIG. 2, respectively.

### Third Exemplary Embodiment

A third exemplary embodiment is described. FIG. 5 is a cross-sectional view of a switch 20 of the exemplary embodiment. In FIG. 5, the switch 20 of the exemplary embodiment includes a press section 21, a medium 22, a piezoelectric element 23, a control section 24, a liquid-resistant sheet 25, a supporting member 26, and an exterior body. The exterior body includes a side plate 27, a bottom plate 28, and a frame plate 29. The control section 24 is typically illustrated.

The press section 21 is formed from a resilient member. The medium 22 is disposed below the press section 21 and is deformed in response to displacement of the press section 21. The medium 22 is encapsulated in a space which is formed of the press section 21, the liquid-resistant sheet 25, and the bottom 28. A non-compressible fluid, like water, or gel can be employed as the medium 22.

In FIG. 5, the piezoelectric element 23 is disposed in the direction orthogonal to the longitudinal direction of the press section 21. The piezoelectric element 23 outputs a voltage, when the medium 22 is deformed in the direction of the x-axis to press the piezoelectric element 23. The piezoelectric element 23 functions as an actuator when a voltage is applied thereto.

The piezoelectric element 23 may be a bimorph piezoelectric element. The bimorph piezoelectric element is formed by sandwiching a metal plate between two ceramic plates whose polarization directions are opposite each other and joining these plates. When the bimorph piezoelectric element is pressed and bending displacement occurs, a voltage is generated due to the piezoelectric effect. If a voltage is applied to the bimorph piezoelectric element to generate bending displacement, the bimorph piezoelectric element functions as an actuator.

The control section 24 detects the voltage outputted from the piezoelectric element 23. The control section 24 further controls timing and magnitude of the voltage to be applied to the piezoelectric element 23.

The liquid-resistant sheet 25 is disposed between the medium 22 and the piezoelectric element 23 and is adhered to the piezoelectric element 23. Since the liquid-resistant sheet 25 is disposed, it is possible to prevent the medium 22, like water, from touching the piezoelectric element 23 to cause electric leakage.

The support member 26 is connected to an end area of a face opposite to the face on which the liquid-resistant sheet 25 is disposed in the piezoelectric element 23. A face of the support member 26 opposite to the face on which the piezoelectric element 23 is disposed is fixed to the side plate 27. The support member 26 is disposed between the end area of the piezoelectric element 23 and the side plate 27. Therefore, a prescribed space is formed between a central area of the piezoelectric element 23 and the side plate 27. Due to the space, the piezoelectric element 23 can be displaced either in the positive direction of the x-axis or in the negative direction thereof A member, for example, a resilient member, that can be deformed in response to displacement of the piezoelectric element 23 is employed as the support member 26.

The side plate 27 is a plate-like member which covers a side face of the switch 20 and, the bottom member 28 is a plate-like member which covers a bottom face of the switch 20. The side plate 27 is fixed to the bottom plate 28 with a screw (not shown), or the like. The press section 21 is disposed on the side plate 27 and is adhered to the side plate 27 with glue, or the like. The frame plate 29 covers an end area of the press section 21 and is adhered to the press section 21 with glue, or the like. The exterior body is formed of the side plate 27, the bottom plate 28 and the frame plate 29.

The side plate 27, the bottom plate 28 and the frame plate 29 can be made of a resin member or a metal member. The side plate 27, the bottom plate 28 and the frame plate 29 can be made of the same material or different materials.

When the switch 20 is configured using these members, the side plate 27 is fixed to the bottom plate 28 with a screw, the support member 26 is fixed to an end part of an inside of the side plate 27 and, further the piezoelectric element 23 to which the liquid-resistant member 25 is adhered is adhered to an inside of the support member 26.

Next, the medium 22 is disposed in a space which is formed of the liquid-resistant member 25 and the bottom plate 28 and, a process, in which air is removed, is conducted. After that, the press section 21 is disposed on the side plate 27, the frame plate 29 is disposed on the end area of the press section 21 and, the press section 21 is fixed to the exterior body which is formed of the side plate 27, the bottom plate 28 and the frame plate 29.

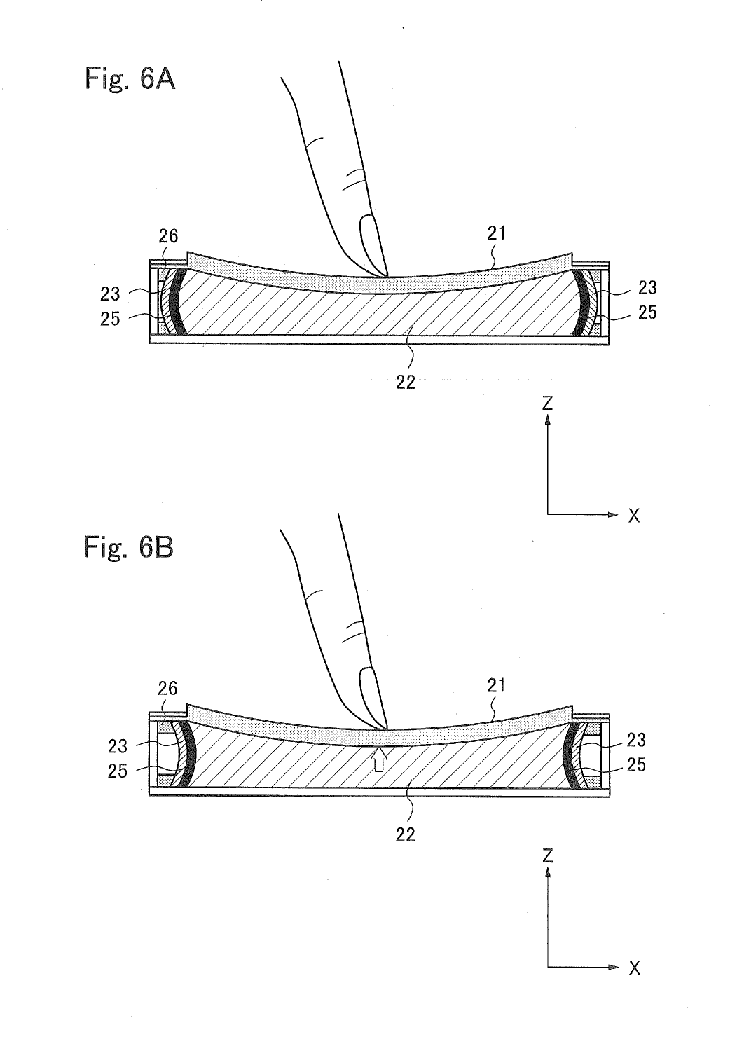

In the switch 20 configured as above descriptions, when a user presses the press section 21, the press section 21 is deformed to become convex in the negative direction of the z-axis, as shown in FIG. 6A. Since the press section 21 is displaced in the negative direction of the z-axis, a pressure is applied to the medium 22 and the medium 22 is deformed. More specifically, when a pressure is applied to the medium 22, density of the medium 22 changes and a pressure change occurs and, thereby the medium 22 is consecutively displaced. As a result of the consecutive displacement of the medium 22, a pressure change occurs in the medium 22 adjacent to the piezoelectric element 23 and bending displacement is generated in the piezoelectric element 23.

Since the piezoelectric element 23 related to the exemplary embodiment is disposed in the direction orthogonal to the longitudinal direction of the press section 21, the displacement direction of the piezoelectric element 23 is the direction of the x-axis. As illustrated in FIG. 6A, the piezoelectric element 23 is deformed to become convex either in the positive direction of the x-axis or in the negative direction thereof. When the deformation in the direction of the x-axis is generated, the piezoelectric element 23 generates the voltage due to the piezoelectric effect. The control section 24 detects the voltage from the piezoelectric element 23 through a conductive line (not shown).

In the exterior body formed of the side plate 27, the bottom plate 28 and the frame plate 29, solid members do not collide with each other when the press section 21 is pressed. A sound which is generated when the press section 21 is pressed, therefore, can be reduced. Since the press section 21 is made of a resilient member and the medium 22 formed of the non-compressible fluid, like water, or gel is disposed below the press section 21, the press section 21 is pressed to be easily deformed. A user can, therefore, have the pressing sensation in which the user's finger moves in the negative direction of the z-axis.

The area around the finger on the press section 21 is relatively displaced in the positive direction of the z-axis with respect to the area where the finger touches. When the area around the finger on the press section 21 is relatively displaced in the positive direction of the z-axis, a user has a sensation in which the area around the finger rises up. Accordingly the user can definitely have the pressing sensation.

In the switch 20 of the exemplary embodiment, if the voltage outputted from the piezoelectric element 23 exceeds a prescribed threshold value, the control section 24 starts to apply a voltage to the piezoelectric element 23. The control section 24 applies the voltage to the piezoelectric element 23 through a conductive line which is different from the conductive line for measuring the voltage outputted from the piezoelectric element 23.

As shown in FIG. 6B, when the voltage is applied to the piezoelectric element 23, displacement in the direction opposite to the direction of the displacement which occurs when the press section 21 is pressed is generated in the piezoelectric element 23. When the piezoelectric element 23 is displaced in the direction opposite to the direction of the displacement which occurs when the press section 21 is pressed, a consecutive pressure change occurs in the medium 22 and the medium 22 pushes the press section 21 back. As a result, a pressure in the positive direction of the z-axis is applied to the press section 21. Therefore, the user's finger is subjected to stress caused by applying the voltage to the piezoelectric element 23 in addition to a resistance force of the press section 21 and the medium 22. Accordingly, the user can definitely have the push-back sensation.

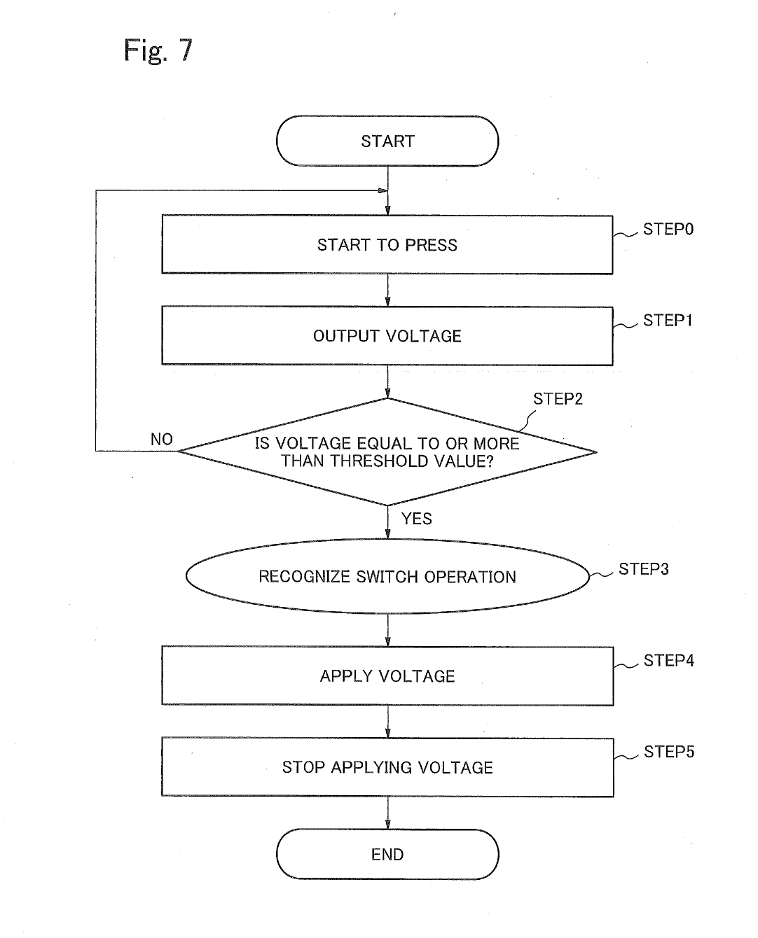

An operation of the control section 24 is described. FIG. 7 illustrates an operation flow in control section 24. In FIG. 7, when a user presses the press section 21 of the switch 20 with the user's finger (step 0), bending displacement occurs in the piezoelectric element 23 and a voltage is outputted (step 1).

The control section 24 compares the voltage outputted from the piezoelectric element 23 with a first threshold value (step 2), and determines that the press section 21 of the switch 20 is pressed if the outputted voltage is equal to or more than a prescribed threshold value (YES in step 2). That is, it is determined that the switch 20 is operated (step 3).

The control section 24 applies a voltage, which is made by adding a prescribed voltage for giving the full push-back sensation to the detected voltage, to the piezoelectric element 23 (step 4). The control section 24 determines that pressing of the press section 21 is completed, for example, when the detected voltage becomes smaller than a threshold value for determining completion of pressing and, the control section 24 stops applying the voltage to the piezoelectric element 23 (step 5).

The switch 20 of the exemplary embodiment is highly quiet and can give the switch pressing sensation and the push-back sensation to a user. In the exemplary embodiment, since the piezoelectric element 23 outputs the voltage in response to bending displacement and presses the medium 22 based on the applied voltage, the switch 20 can be downsized compared with a structure configured by a discrete part for outputting a voltage and another discrete part for pressing the medium 22.

In the exemplary embodiment, the control section 24 compares the measured voltage with the threshold value and determines whether or not the switch 20 is operated. However, the invention is not limited to the above operation. The control section 24 may calculate an amount of displacement of the piezoelectric element 23 or the press section 21 based on the measured voltage, compare the calculated amount of displacement with a prescribed threshold value and, determine whether or not the switch 20 is operated.

In the exemplary embodiment, the exterior body is configured by using the side plate 27, the bottom plate 28 and the frame member 29. The exterior member may be configured by a unified or one-body component. The exterior body may be configured by using a unified component including the support member 26 and the side plate 27 and, the frame member 29. Each of the members may be fixed with a screw, instead of fixing with an adhesive agent. The piezoelectric element 23 may be not only the bimorph piezoelectric element, but a monomorph piezoelectric element, a unimorph piezoelectric element, or the like.

### Fourth Exemplary Embodiment

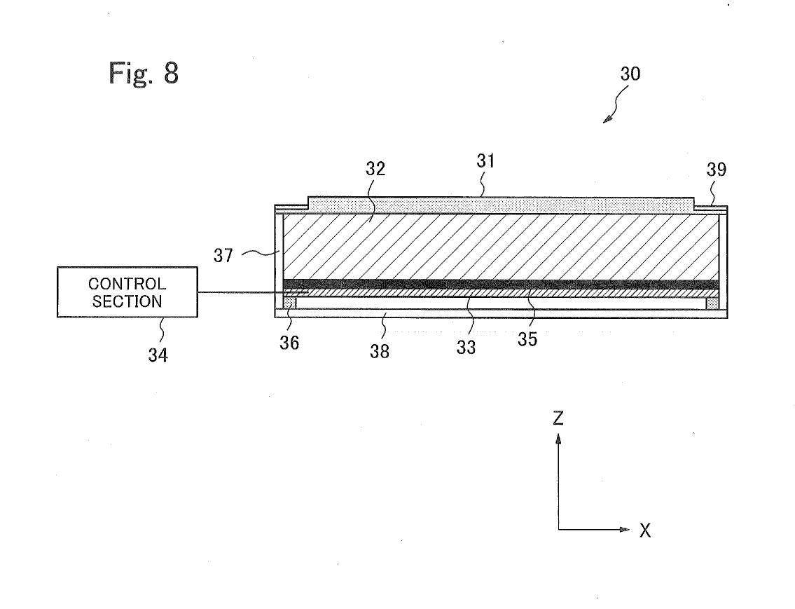

A fourth exemplary embodiment is described. FIG. 8 is a cross-sectional view of a switch of the exemplary embodiment. A press section 31 faces a piezoelectric element 33 through a medium 32 and a liquid-resistant sheet 35. A support member 36 is disposed between an end area of the piezoelectric element 33 and a bottom plate 38. The piezoelectric element 33 can be displaced either in the positive direction of the z-axis or in the negative direction thereof, due to the support member 36. The medium 32 is encapsulated in a closed space which is formed of the press section 31, a side plate 37 and the liquid-resistant sheet 35.

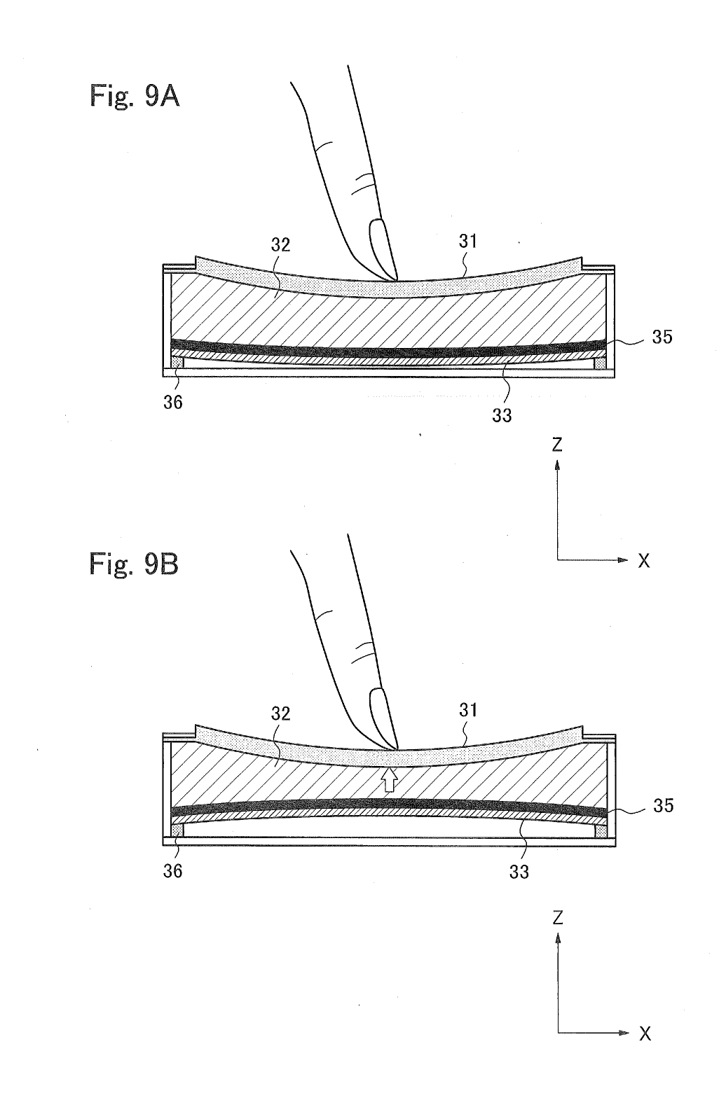

When a user presses the press section 31 in the negative direction of the z-axis with the user's finger, a switch 30 configured as the above description is deformed such that the press section 31 becomes convex in the negative direction of the z-axis, as shown in FIG. 9A. When the press section 31 is deformed in the negative direction of the z-axis, the medium 32 is consecutively displaced and presses the piezoelectric element 33. Since the piezoelectric element 33 faces the press section 31, the piezoelectric element 33 is deformed so as to become convex in the negative direction of the z-axis and outputs a voltage by the piezoelectric effect, when the medium 32 presses the piezoelectric element 33.

In the switch 30 related to the exemplary embodiment, solid members do not collide with each other when the press section 31 is pressed. A sound which is generated when the press section 31 is pressed, therefore, can be reduced. The switch 30 related to the exemplary embodiment can give a user a sensation in which the user's finger moves in the direction of the z-axis and a sensation in which an area around the finger rises up. The user can have a definite pressing sensation.

In the switch 30 configured as the description above, a control section 34 detects the voltage outputted from the piezoelectric element 33 through a conductive line (not shown). If the voltage outputted from the piezoelectric element 33 exceeds a prescribed threshold value, the control section 34 starts to apply a voltage to the piezoelectric element 33. The control section 34 applies the voltage to the piezoelectric element 33 through a conductive line which is different from the conductive line for measuring the voltage outputted from the piezoelectric element 33.

As shown in FIG. 9B, when the voltage is applied to the piezoelectric element 33, the piezoelectric element 33 is deformed so as to become convex in the positive direction of the z-axis. Since the piezoelectric element 33 is deformed so as to become convex in the positive direction of the z-axis, the medium 32 is consecutively displaced to press the press section 31 in the positive direction of the z-axis. When the press section 31 is pressed in the positive direction of the z-axis, the press section 31 is pushed back.

The switch 30 related to the exemplary embodiment adds stress in the positive direction of the z-axis caused by applying a voltage to the piezoelectric element 33 to the user's finger touching the press section 31, in addition to a resistance force of the press section 31 and the medium 32. The user can, therefore, have a definite push-back sensation.

As mentioned above, the switch 30 of the exemplary embodiment is highly quiet and can give the switch pressing sensation and the push-back sensation to a user.

If both the piezoelectric element 33 and the press section 31 are disposed in the direction of the x-axis, an area of contact between the piezoelectric element 33 and the medium 32 can be fully secured. In this case, even though the length of the switch 30 in the direction of the z-axis is shortened so that the switch 30 is formed thinly, the switch 30 can sense, with high accuracy, that the press section 31 is pressed.

### Fifth Exemplary Embodiment

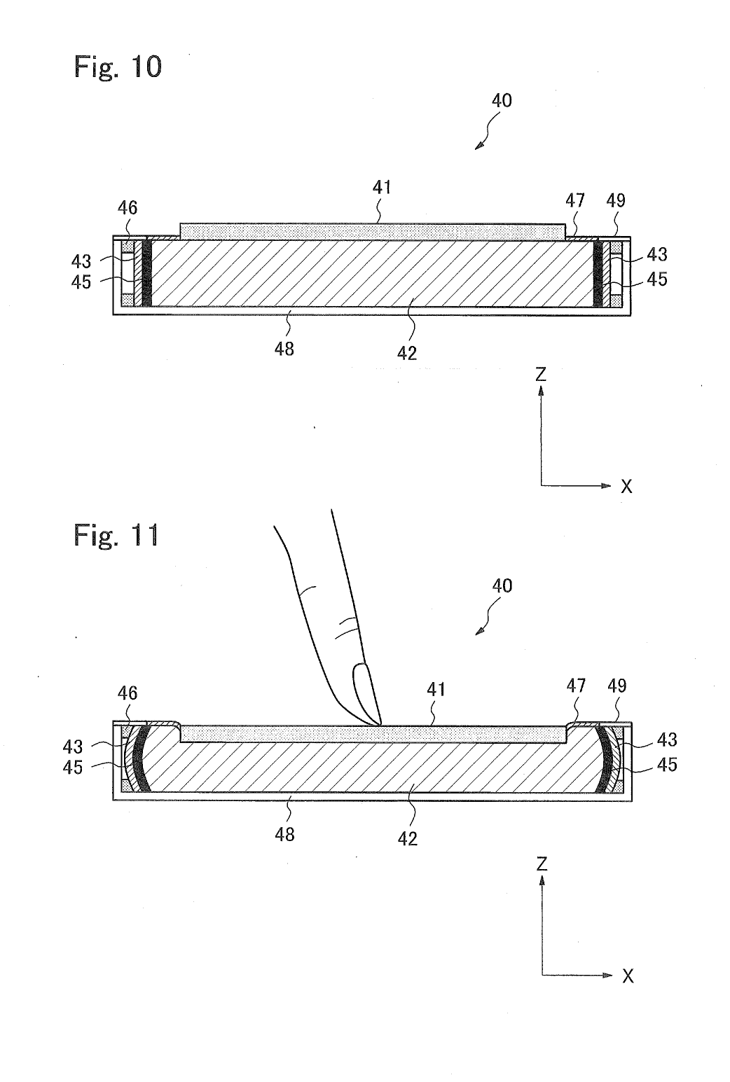

A fifth exemplary embodiment is described. FIG. 10 is a cross-sectional view of a switch related to the exemplary embodiment. A switch 40 related to the exemplary embodiment is formed by changing the structure of the press section of the switch 20 related to the third exemplary embodiment.

The switch 40 related to the exemplary embodiment includes a press section 41 made of a non-resilient member, a support body 47 made of a resilient member, and an exterior body 48 which is a box whose upper side is removed. The support body 47 is fixed around the press section 41 and supports the press section 41. The support body 47 is fixed to a frame plate 49. A medium 42 is encapsulated in a closed space which is formed of the press section 41, the support body 47, a liquid-resistant sheet 45, and the exterior body 48. A support member 46 is disposed between a piezoelectric element 43 and the exterior body 48.

In the switch 40 configured as the above description, when a user presses the press section 41 in the negative direction of the z-axis with the user's finger, the support body 47 connected to the press section 41 bends and the press section 41 is displaced in the negative direction of the z-axis. When the press section 41 is displaced in the negative direction of the z-axis, the medium 42 is consecutively displaced to press the piezoelectric element 43.

When being pressed by the medium 42, the piezoelectric element 43 is deformed so as to become convex either in the positive direction of the x-axis or the negative direction thereof to output a voltage.

In the switch 40 related to the exemplary embodiment, when the press section 41 is pressed, solid members do not collide with each other, and a sound which occurs when the press section 41 is pressed can be reduced. In the switch 30 related to the exemplary embodiment, since the support body 47 formed of a resilient member supports the press section 41, the support body 47 bends downward when a user presses the press section 41 and the press section 41 is displaced downward. Therefore, a user has a sensation in which the user's finger moves in the direction of the z-axis.

In the switch 40 related to the exemplary embodiment, a control section (not shown) detects a voltage outputted from the piezoelectric element 43, and when the voltage outputted from the piezoelectric element 43 exceeds a prescribed threshold value, the control section starts to apply a voltage to the piezoelectric element 43. When the voltage is applied to the piezoelectric element 43, the piezoelectric element 43 is displaced in the direction opposite to the direction in which the medium 42 presses the piezoelectric element 43. The piezoelectric element 43 is displaced so as to become convex either in the negative direction of the x-axis or in the positive direction thereof.

Since the piezoelectric element 43 is displaced in the direction opposite to the direction in which the medium 42 presses the piezoelectric element 43, the medium 42 is consecutively displaced and pushes the press section 41 back.

The switch 40 related to the exemplary embodiment adds stress in the positive direction of the z-axis caused by applying the voltage to the piezoelectric element 43 to the user's finger touching the press section 41, in addition to a resistance force of the medium 42. The user can, therefore, have a definite push-back sensation.

As mentioned above, the switch 40 of the exemplary embodiment is highly quiet and can give the switch pressing sensation and the push-back sensation to a user. In the exemplary embodiment, the press section 41 is formed of a non-resilient member. In this case, the user has a sensation of contact with a membrane switch having a pantograph mechanism.

### Sixth Exemplary Embodiment

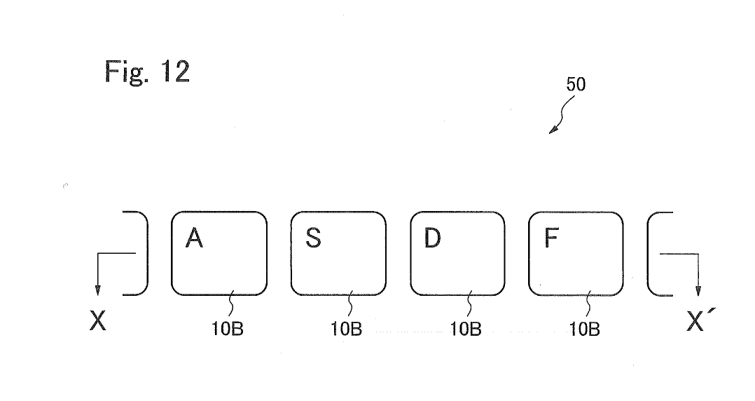

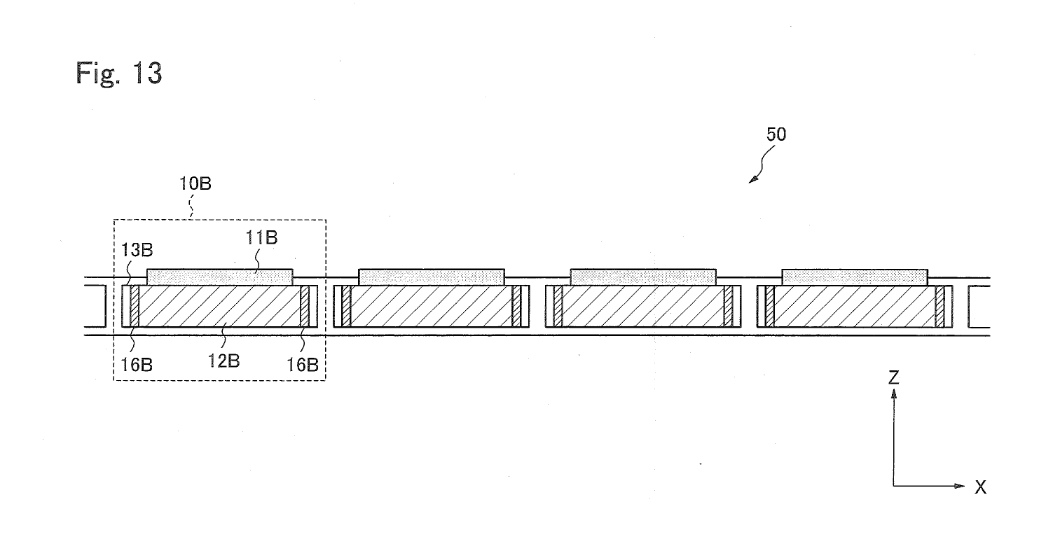

A sixth exemplary embodiment is described. FIG. 12 illustrates a top view of an input device 50 related to the sixth exemplary embodiment. FIG. 13 illustrates a cross-sectional view of the input device 50 illustrated in FIG. 12 along the line X-X′.

In FIG. 12, when a switch 10B is pressed, the input device 50 inputs character information on an alphabetical character associated with the pressed switch 10B into a prescribed electronic apparatus. In the exemplary embodiment, the character information inputted with the input device 50 is displayed on a display section disposed inside or outside the electronic apparatus.

In FIG. 12 and FIG. 13, the input device 50 includes a plurality of switches 10B disposed in a two-dimensional matrix. An exterior body 13B is formed of a resin member or a metal member, and is molded with another exterior body 13B of the switch 10B adjacent to each other. Each of the plurality of switches 10B includes the same configuration as that of the switch 10B illustrated in FIG. 4 and described in the second exemplary embodiment.

In the input device 50 configured as above description, when a user selects one switch 10B in the plurality switches 10B and presses the selected switch 10B, a press section 11B is displaced in the negative direction of the z-axis and a medium 12B presses a piezoelectric element 16B. The piezoelectric element 16B is pressed to output a voltage.

When detecting the voltage outputted from the piezoelectric element 16B, a control section 17B (not shown) determines that the switch is operated. The input device 50 inputs the character information associated with the operated switch 10B into the prescribed electronic apparatus.

Determining that the switch is operated, the control section 17B (not shown) starts to apply a voltage to the piezoelectric element 16B. When the voltage is applied to the piezoelectric element 16B, the piezoelectric element 16B is deformed so as to become convex in the positive direction of the z-axis. The medium 32 is consecutively displaced in association with deformation of the piezoelectric element 16B and presses the press section 31 in the positive direction of the z-axis.

In the switch 50 related to the exemplary embodiment, when the press section 11B is pressed, solid members do not collide with each other, and a sound which occurs when the press section 11B is pressed can be reduced. When the press section 11B is displaced in the negative direction of the z-axis, the input device 50 can give a user a pressing sensation of the switch 10B. In the input device 50, a voltage is applied to the piezoelectric element 16B when the switch 10B is operated and, the press section 11B is pushed back in the positive direction of the z-axis through the medium 32. Stress in the positive direction of the z-axis is therefore applied to the user's finger touching the press section 11B, and the user can have the switch push-back sensation.

The input device 50 of the exemplary embodiment is highly quiet and can give a user the pressing sensation and the push-back sensation.

In the exemplary embodiment, the exterior bodies 13B of the switches 10B adjacent to each other are molded together. However, the exterior body may be separately molded for each switch. A prescribed threshold value is set for the input device 50. In the case, when a voltage outputted from the piezoelectric element 16B is equal to or more than the threshold value, the input device 50 inputs the character information and starts to apply a voltage to the piezoelectric element 16B.

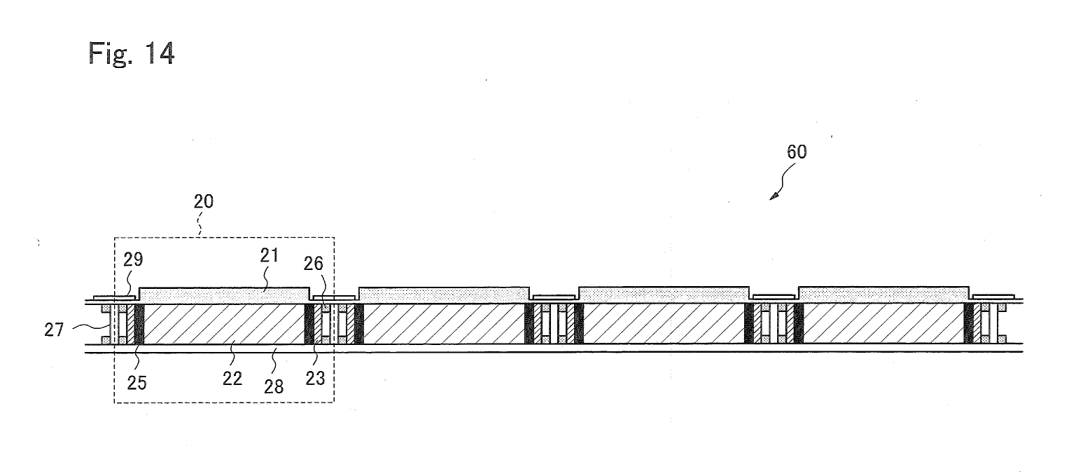

The input device 50 of the exemplary embodiment includes the plurality of the switches 10B illustrated in FIG. 4. The input device 50 may include the plurality of switches including the switch 20, the switch 30, and the switch 40 described in the third exemplary embodiment to the fifth exemplary embodiment, respectively. FIG. 14 is a cross-sectional view of an input device 60 having the plurality of switches 20 of the third exemplary embodiment. In FIG. 14, the press section 21, the side plate 27 and the frame plate 29 of the switch 20 are molded with the press section 21, the side plate 27 and the frame plate 29 of the switch 20 adjacent thereto, respectively. In the case, the switches 20 adjacent to each other are separated by the side plate 27.

While having described an invention of the present application referring to the embodiments, the invention of the present application is not limited to the above mentioned embodiments. It is to be understood that to the configurations and details of the invention of the present application, various changes can be made within the scope of the invention of the present application by those skilled in the art. A part or all of the above exemplary embodiments may be described as following supplemental notes, however is not limited to the following.

### (Supplemental Note 1)

A switch comprising: a press section; a medium which is disposed below the press section and is able to be deformed in response to displacement of the press section; an exterior body for covering the medium; a sensor for sensing that the press section is pressed; and a driving section, wherein when the sensor senses that the press section is pressed, the driving section drives so that a force in the direction opposite to the direction in which the press section is pressed is applied to the press section.

### (Supplemental Note 2)

The switch of the supplemental note 1, wherein the press section is formed of a resilient member.

### (Supplemental Note 3)

The switch of the supplemental note 1 or the supplemental note 2, further comprising a support body which is fixed around the press section and supports the press section, wherein the support body is formed of a resilient member.

### (Supplemental Note 4)

The switch of any one of the supplemental notes 1 to 3, comprising a piezoelectric element which is the sensor and is also the driving section; and a control section for controlling the piezoelectric element, wherein the piezoelectric element is displaced in the first direction in response to deformation of the medium to generate a voltage, when the piezoelectric element generates the voltage the control section applies a voltage to the piezoelectric element, and the piezoelectric element is displaced in the direction opposite to the first direction when the voltage is applied thereto.

### (Supplemental Note 5)

The switch of the supplemental note 4, wherein the control section applies the voltage to the piezoelectric element when the voltage generated by the piezoelectric element is equal to or more than a prescribed value.

### (Supplemental Note 6)

The switch of the supplemental note 4 or the supplemental note 5, wherein the direction in which the piezoelectric element is displaced is orthogonal to the direction in which the press section is displaced.

### (Supplemental Note 7)

The switch of the supplemental note 4 or the supplemental note 5, wherein the direction in which the piezoelectric element is displaced is the same as the direction in which the press section is displaced.

### (Supplemental Note 8)

The switch of any one of the supplemental notes 4 to 7, wherein a liquid-resistant sheet is disposed between the piezoelectric element and the medium.

### (Supplemental Note 9)

The switch of any one of the supplemental notes 4 to 8, wherein the piezoelectric element is a bimorph piezoelectric element.

### (Supplemental Note 10)

An input device comprising: a plurality of the switches of any one of the supplemental notes 1 to 9, wherein when the press section is pressed, prescribed information is inputted into a prescribed electronic apparatus.

### (Supplemental Note 11)

The input device of the supplemental note 10, wherein at least a part of the exterior body is molded together with respect to the switches adjacent to each other in the plurality of switches.

This application claims priority from Japanese Patent Application No. 2011-010873 filed on Jan. 21, 2011, the contents of which are incorporation herein by reference in their entirety.

### INDUSTRIAL APPLICABILITY

The switch and the input device of the invention are applicable to an input switch of various devices, a power switch of an electric apparatus, an input device of a keyboard, or the like.

### DESCRIPTION OF SYMBOL

1 switch
2 pressure transmitting member
3 push-back member
10, 10B, 20, 30, 40 switch
11, 11B, 21, 31, 41 press section
12, 12B, 22, 32, 42 medium
13, 13B, 48 exterior body
14 sensor
14 driving section
16B, 23, 33, 43 piezoelectric element
17B, 24, 34 control section
25, 35, 45 liquid-resistant sheet
26, 36, 46 support member
27, 37 side plate
28, 38 bottom plate
29, 39, 49 frame plate
47 support body
50, 60 input device

1. A switch comprising:
a pressure transmitting member, which is formed from a medium that transfers changes in pressure and which transfers a pressure change to a prescribed direction when pressed; and
a push-back member that is disposed adjacent to the pressure transmitting member and pushes the pressure transmitting member back in the direction opposite to the prescribed direction when a transmission of the pressure change in the prescribed direction is detected.

2. The switch according to claim 1 further comprising:
an applying member that applies an applied voltage to the push-back member when the pressure change is transferred in the prescribed direction,
wherein the push-back member pushes the pressure transmitting member back by bending in the direction opposite to the prescribed direction, when the applied voltage is applied from the applying member.

3. The switch according to claim 2,
wherein when bending in the prescribed direction, the push-back member determines the pressure change is transferred and outputs an output voltage, and
wherein when the output voltage is outputted from the push-back member, the applying member applies the applied voltage to the push-back member.

4. The switch according to claim 3,
wherein when the output voltage outputted from the push-back member is equal to or larger than a prescribed threshold value, the applying member applies the applied voltage to the push-back member.

5. The switch according to claim 3,
wherein the applied voltage is the voltage that is made by adding a prescribed voltage to the output voltage outputted from the push-back member.

6. The switch according to claim 1,
wherein the pressure transmitting member is formed by encapsulating a liquid in a closed space that is formed by using a liquid-resistant sheet.

7. The switch according to claim 1 further comprising:
a solid member that is disposed on the pressure transmitting member and moves downward when being pressed by a user,
wherein the pressure transmitting member is pressed when the solid member moves downward.

8. The switch according to claim 7 further comprising:
an exterior body on which the solid member is disposed and in which the solid member and the push-back member are disposed.

9. The switch according to claim 1,
wherein the push-back member comprises a bimorph piezoelectric element.

10. An input device, comprising a plurality of the switches according to claim 1 and, that is characterized by inputting information corresponding to the pressed switch into a prescribed electric device when the pressure transmitting member in the switch is pressed.
